(19) United States
(12) Patent Application Publication
(10) Pub. No.: US 2017/0048023 A1
(43) Pub. Date: Feb. 16, 2017

(54) APPARATUS TO TRANSMIT DATA USING DIFFERENT SCRAMBLE GENERATOR POLYNOMIALS

(71) Applicant: FUJITSU LIMITED, Kawasaki-shi (JP)

(72) Inventor: KATSUYA TSUSHITA, Saitama (JP)

(73) Assignee: FUJITSU LIMITED, Kawasaki-shi (JP)

(21) Appl. No.: 15/226,131

(22) Filed: Aug. 2, 2016

(30) Foreign Application Priority Data
Aug. 13, 2015 (JP) 2015-159938

(51) Int. Cl. H04L 1/00

(52) U.S. Cl. CPC H04L 1/0046; H04L 1/0011

(57) ABSTRACT

A first processor included in a transmission device stores a first generator polynomial in a portion of a first data scrambled by using the first generator polynomial, and transmits the first data including the first generator polynomial. A second processor included in a reception device receives the first data, descrambles the first data by using the first generator polynomial, and generates a second data by scrambling the descrambled first data by using a second generator polynomial different from the first generator polynomial.

### CROSS-REFERENCE TO RELATED APPLICATION

This application is based upon and claims the benefit of priority of the prior Japanese Patent Application No. 2015-159938, filed on Aug. 13, 2015, the entire contents of which are incorporated herein by reference.

### FIELD

The embodiments discussed herein relate to apparatus to transmit data using different scramble generator polynomials.

### BACKGROUND

A transmission system has a signal processing method which involves extracting a clock from received signals and processing the received signals in synchronization with the extracted clock. As for a signal processing method, method is known which involves transmitting the signal by using a generator polynomial to scramble data and generating a signal with an ensured DC balance because appropriate clock extraction is not carried out when the same continuous codes are included in the received signals. Examples of the prior include Japanese Laid-open Patent Publication No. 07-202881 and International Publication Pamphlet No. WO 2011/004838.

### SUMMARY

According to an aspect of the invention, a system includes a transmission device and a reception device. A first processor included in the transmission device is configured to store a first generator polynomial in a portion of a first data scrambled by using the first generator polynomial, and transmit the first data including the first generator polynomial. A second processor included in the reception device is configured to receive the first data, descramble the first data by using the first generator polynomial, and generate a second data by scrambling the descrambled first data by using a second generator polynomial different from the first generator polynomial.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a transmission system, according to an embodiment;

FIG. 2 is a diagram illustrating an example of storing a generator polynomial in an overhead of a frame, according to an embodiment;

FIGS. 3A and 3B are diagrams each illustrating an example of a bit string expression of a generator polynomial, according to an embodiment;

FIG. 4 is a diagram illustrating an example of a transmission device, according to an embodiment;

FIG. 5 is a diagram illustrating an example of a scramble processing unit (descramble processing unit), according to an embodiment;

FIG. 6 is a diagram illustrating an example of an operational flowchart for determining a generator polynomial, according to an embodiment;

FIG. 7 is a diagram illustrating an example of a transmission system, according to an embodiment;

FIG. 8 is a diagram illustrating an example of multistage encapsulating, according to an embodiment;

FIG. 9 is a diagram illustrating an example of a transmission system, according to an embodiment; and

FIG. 10 is a diagram illustrating an example of a transmission system, according an embodiment.

### DESCRIPTION OF EMBODIMENTS

There is a problem with the above technique in that when a device anticipated to receive a scrambled signal receives a signal that is not scrambled, the unscrambled signal is transmitted when retransmitting the received signals over a transmission path. The reason that this problem occurs is that the descrambling is carried out when performing scrambling again with the same generator polynomial that was used when the data to be scrambled was scrambled. Specifically, when the device anticipated to receive the scrambled signal receives an unscrambled signal, scrambling is carried out (without canceling the scrambling) on the signal received due to the descramble processing. When transmitting the signal, the descramble processing is carried out according to the scramble processing. As a result, the device transmits signals, which have not been scrambled, and in which the same codes are continued, when retransmitting the received signals over the transmission path.

As a result, a device that receives the signals, which have not been scrambled, and in which the same codes are continued, is not able to extract an appropriate clock from the received signals and a processing error is generated and a false detection of a transmission path abnormality such as a loss of signal (LOS) may occur.

It is preferable to avoid the transmission of signals in which the same codes are continued.

A transmission system and a transmission device related to the embodiments will be explained with reference to the attached drawings. The following explanation of the embodiments discusses only configurations related to the disclosed techniques and explanations of other techniques are omitted. In the explanation of the following embodiments, the explanation of overlapping or similar configurations or processing may be omitted. The following embodiments are not intended to limit the techniques disclosed herein. The embodiments may be combined as appropriate within a consistent scope.

### First Embodiment

### Transmission System According to First Embodiment

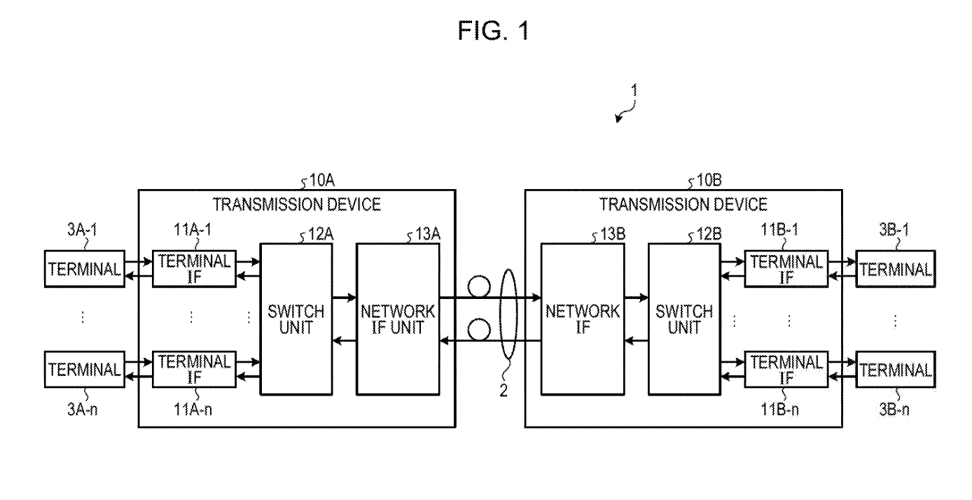

FIG. 1 is a block diagram of an example of a transmission system according to the first embodiment. As illustrated in FIG. 1, a transmission system 1 according to the first embodiment includes transmission devices 10A to 10B coupled over a transmission path 2, terminals 3A-1 to 3A-n coupled to the transmission device 10A, and terminals 3B-1 to 3B-n (n is a natural number) coupled to the transmission device 10B. The transmission and reception of data by the transmission system 1 is understood to be carried out with frames. However, the techniques disclosed herein are not limited to frames and any data format conforming to a communication protocol used by a transmission system, such as packets or cells and the like, may be used.

The transmission device 10A includes terminal interface (IF) 11A-1 to 11A-n, a switch unit 12A, and a network IF 13A. The terminal IFs 11A-1 to 11A-n are coupled respectively to the terminals 3A-1 to 3A-n. The terminal IFs 11A-1 to 11A-n output transmission data from the terminals 3A-1 to 3A-n to the switch unit 12A. Moreover, the terminal IFs 11A-1 to 11A-n output, to the respective terminals 3A-1 to 3A-n, reception data as addresses of the respective terminals 3A-1 to 3A-n outputted from the switch unit 12A.

The switch unit 12A carries out forwarding control, in accordance with the addresses, on the transmission data outputted from the terminal IFs 11A-1 to 11A-n, and outputs the data to the network IF 13A. Moreover, the switch unit 12A carries out forwarding control, in accordance with the addresses, on the reception data outputted from the network IF 13A, and outputs the data to the terminal IFs 11A-1 to 11A-n which are coupled to the respective terminals 3A-1 to 3A-n indicated by the addresses.

The network IF 13A transmits the transmission data outputted by the switch unit 12A to the transmission device 10B via the transmission path 2. Moreover, the network IF 13A outputs the reception data received from the transmission device 10B via the transmission path 2 to the switch unit 12A. The transmission device 10B has the same configuration and processing functions as the transmission device 10A. The transmission device 10A and the transmission device 10B may be collectively referred to hereinbelow as the transmission device 10.

(Method for Storing Generator Polynomial in Frame According to First Embodiment)

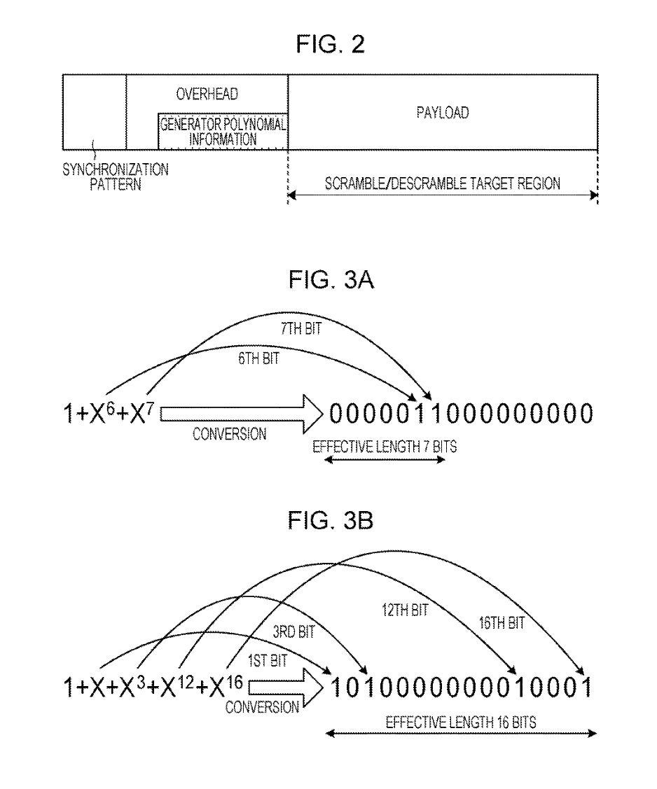

FIG. 2 is a view illustrating an example of storing a generator polynomial in an overhead of a frame according to the first embodiment. In the first embodiment, a generator polynomial used for scrambling or descrambling target data is converted to a bit string expression that is able to be uniquely identified. That is, the generator polynomial and the target data to be scrambled or descrambled with the generator polynomial are associated with each other in the first embodiment.

In the first embodiment, the transmission device 10 on the transmission side maps the generator polynomial information converted to the bit string expression to a predetermined region of the overhead of the transmission data, maps the data to be scrambled to the payload of the transmission data by using the generator polynomial, and then transmits the data. Furthermore, the transmission device 10 on the reception side extracts the generator polynomial information mapped to the predetermined region of the overhead from the reception data received from the transmission device 10 on the transmission side in the first embodiment. The transmission device 10 on the reception side then descrambles the scrambled target data mapped to the payload of the reception data, by using the generator polynomial corresponding to the extracted generator polynomial information.

In this way, the transmission devices 10 on the transmission side and the reception side use the same generator polynomial in conjunction, thereby allowing the transmission device 10 on the reception side to descramble the transmission data scrambled and transmitted by the transmission device 10 on the transmission side, by appropriately switching the generator polynomial for each set of transmission data.

(Bit String Expression of Generator Polynomial)

FIGS. 3A and 3B are views illustrating an example of a bit string expression of a generator polynomial according to the first embodiment. FIGS. 3A and 3B illustrate cases in which the predetermined region of the frame that stores the generator polynomial information in FIG. 2 is a 16-bit region. That is, the maximum order of the generator polynomial is 16 bits. As illustrated in FIG. 3A, when the generator polynomial is, for example, 1+X⁶+X⁷ in the first embodiment, 0 is set to the first to fifth bits from the start of the bit string corresponding to the terms x¹ to x⁵, and 1 is set to the sixth to seventh bits from the start of the bit string corresponding to the terms x⁶ and x⁷. Then, generator polynomial information in which 0 is set to the 8th to 16th bits from the start of the bit string is generated in the first embodiment. The generator polynomial 1+X⁶+X⁷ is able to be identified as having an effective length of 7 bits because the 7th bit from the start of the bit string is 1 and bits subsequent to the 8th bit are 0.

As illustrated in FIG. 3B, when the generator polynomial is 1±x±x³+x¹²+x¹⁶, for example, in the first embodiment, 1 is set to the 1st, 3rd, 12^{th}, and 16th bits from the start of the bit string corresponding to the terms x¹, x³, x¹², and x¹⁶. Then, generator polynomial information in which 0 is set to the 2nd, 4th to 11th, and 13th to 15th bits from the start of the bit string corresponding to the terms x², x⁴ to x¹¹, and x¹³ to x¹⁵ is generated in the first embodiment. The generator polynomial 1+x+x³+x¹²±x¹⁶ is able to be identified as having an effective length of 16 bits corresponding to the maximum order because the 16th bit from the start of the bit string is 1.

(Block of Transmission Device According to the First Embodiment)

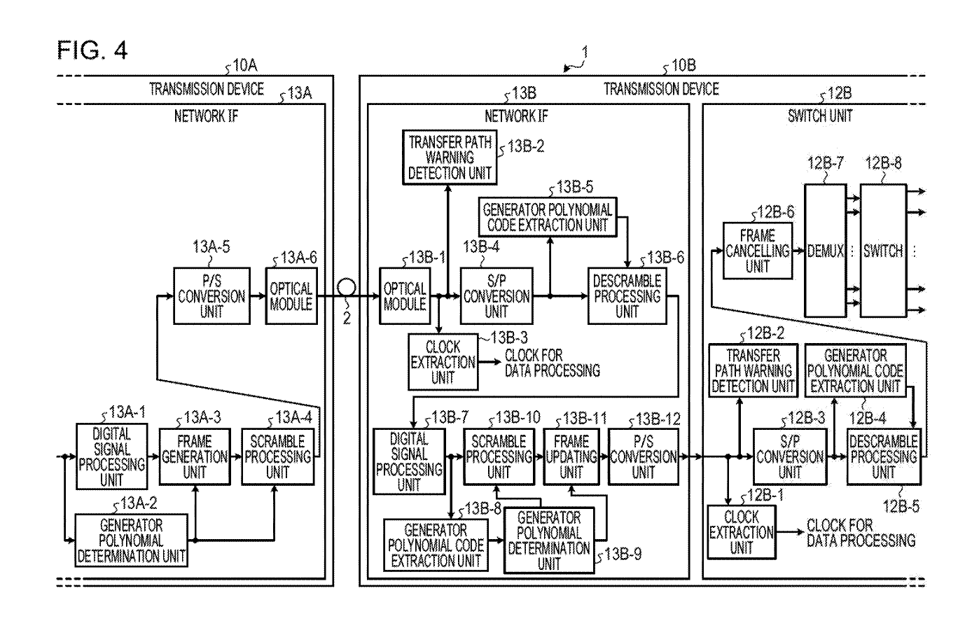

FIG. 4 is a block diagram of an example of a transmission device according to the first embodiment. FIG. 4 illustrates configurations of the transmission device 10A and the transmission device 10B included in the transmission system 1 illustrated in FIG. 1, and is an example in which the transmission device 10A is on the transmission side and the transmission device 10B is on the reception side. Description on the other configurations is omitted here.

As illustrated in FIG. 4, the network IF 13A of the transmission device 10A includes a digital signal processing unit 13A-1, and a generator polynomial determination unit 13A-2. Moreover, the network IF 13A includes a frame generation unit 13A-3, a scramble processing unit 13A-4, a parallel/serial (P/S) conversion unit 13A-5, and an optical module 13A-6.

The digital signal processing unit 13A-1 executes predetermined digital signal processing on the data outputted from the switch unit 12A (see FIG. 1). The generator polynomial determination unit 13A-2 determines, in parallel with the processing by the digital signal processing unit 13A-1, the generator polynomial to be used when scrambling the data outputted from the switch unit 12A. For example, the generator polynomial determination unit 13A-2 determines the generator polynomial in response to whether an effective cyclic bit length is able to be ensured in accordance with the reception port and channel of the data, the path of the data, the protocol used by the data, and the data length. Moreover, the generator polynomial determination unit 13A-2 determines a generator polynomial different from the predetermined generator polynomial when the data to be scrambled includes data that has already been scrambled in a previous stage with the predetermined generator polynomial.

The frame generation unit 13A-3 stores, in the payload, data which has been subjected to the digital signal processing by the digital signal processing unit 13A-1 and is to be scrambled by the scramble processing unit 13A-4. The frame generation unit 13A-3 then generates a frame that stores, in the payload, a bit string obtained by encoding the generator polynomial determined by the generator polynomial determination unit 13A-2.

The scramble processing unit 13A-4 scrambles the data that is to be scrambled and stored in the frame generated by the frame generation unit 13A-3, and stores the scrambled data in the payload. The P/S conversion unit 13A-5 carries out parallel-serial conversion on the transmission data in which the target data is scrambled by the scramble processing unit 13A-4. The optical module 13A-6 converts the data converted by the P/S conversion unit 13A-5, from electrical signals to optical signals, and transmits the data to the transmission path 2.

Moreover, the network IF 13B of the transmission device 10B includes an optical module 13B-1, a transmission path warning detection unit 13B-2, a clock extraction unit 13B-3, an S/P conversion unit 13B-4, a generator polynomial code extraction unit 13B-5, and a descramble processing unit 13B-6. The network IF 13B also includes a digital signal processing unit 13B-7, a generator polynomial code extraction unit 13B-8, a generator polynomial determination unit 13B-9, a scramble processing unit 13B-10, a frame updating unit 13B-11, and a P/S conversion unit 13B-12.

The optical module 13B-1 converts the reception data received from the transmission device 10A via the transmission path 2, from optical signals to electrical signals. The transmission path warning detection unit 13B-2 monitors the data converted into electrical signals by the optical module 13B-1 and detects a warning as an abnormality of the transmission path 2 when, for example, there are a predetermined number of continuous 0 bits. The clock extraction unit 13B-3 extracts a clock from the rising and trailing cycle of the clock in the data converted into electrical signals by the optical module 13B-1. The clock extracted by the clock extraction unit 13B-3 is used as the processing clock for the data in the network IF 13B.

The S/P conversion unit 13B-4 converts the data converted into electrical signals by the optical module 13B-1, from serial data into parallel data for each address. The generator polynomial code extraction unit 13B-5 extracts the code which represents the generator polynomial stored in the overhead of the data converted into parallel data by the S/P conversion unit 13B-4. The descramble processing unit 13B-6 descrambles of the data stored in the payload of the data converted into parallel data by the S/P conversion unit 13B-4, by using the generator polynomial specified from the code extracted by the generator polynomial code extraction unit 13B-5.

The digital signal processing unit 13B-7 carries out digital signal processing on the descrambled data stored in the payload and descrambled by the descramble processing unit 13B-6. The generator polynomial code extraction unit 13B-8 extracts the code which represents the generator polynomial stored in the overhead of the data subjected to the digital signal processing by the digital signal processing unit 13B-7. The generator polynomial determination unit 13B-9 selects and determines, from a generator polynomial list for example, a generator polynomial different from the generator polynomial specified by the code extracted by the generator polynomial code extraction unit 13B-8.

The scramble processing unit 13B-10 uses the generator polynomial determined by the generator polynomial determination unit 13B-9 to scramble the data subjected to the digital signal processing by the digital signal processing unit 13B-7. The frame updating unit 13B-11 updates the frame by storing the data scrambled by the scramble processing unit 13B-10 in the payload and storing the code of the generator polynomial determined by the generator polynomial determination unit 13B-9 in the overhead. The P/S conversion unit 13B-12 serially converts the frame of the parallel data updated by the frame updating unit 13B-11.

As illustrated in FIG. 4, the switch unit 12B of the transmission device 10B includes a clock extraction unit 12B-1, a transmission path warning detection unit 12B-2, an S/P conversion unit 12B-3, a generator polynomial code extraction unit 12B-4, and a descramble processing unit 12B-5. The switch unit 12B also includes a frame cancelling unit 12B-6, a demultiplexer (DEMUX) 12B-7, and a switch 12B-8.

The clock extraction unit 12B-1 extracts the clock from the rising and trailing cycle of the clock in the serially-converted data converted by the P/S conversion unit 13B-12 in the network IF 13B. The clock extracted by the clock extraction unit 12B-1 is used as the processing clock for the data in the switch unit 12B. The transmission path warning detection unit 12B-2 monitors the serially-converted data converted by the P/S conversion unit 13B-12 of the network IF 13B and outputs a warning as an abnormality of the transmission path between the network IF 13B and the switch unit 12B when, for example, there are a predetermined number of continuous 0 bits.

The S/P conversion unit 12B-3 carries out parallel conversion on the serially-converted data converted by the P/S conversion unit 13B-12 of the network IF 13B. The generator polynomial code extraction unit 12B-4 extracts the code representing the generator polynomial from the overhead of the data subjected to parallel conversion by the S/P conversion unit 12B-3. The descramble processing unit 12B-5 descrambles the data stored in the payload of the data converted into parallel data by the S/P conversion unit 12B-3, by using the generator polynomial specified from the code extracted by the generator polynomial code extraction unit 12B-4.

The frame cancelling unit 12B-6 cancels the frame of the descrambled data in the payload descrambled by the descramble processing unit 12B-5. The DEMUX 12B-7 demultiplexes the data of the frame canceled by the frame cancelling unit 12B-6 and outputs the data to the switch 12B-8. The switch 12B-8 carries out forwarding control on the data outputted by the DEMUX 12B-7 for each address and outputs the data to the respective routes.

That is, according to the configuration of the transmission system 1 depicted in FIG. 4, the transmission device 10A determines the scramble generator polynomial for scrambling the transmission data and inserts the generator polynomial into an overhead portion of the frame data when a frame is generated by the network IF 13A. The transmission device 10A then transmits the data scrambled according to the generator polynomial, to the transmission device 10B. The transmission device 10B extracts the encoded generator polynomial from the overhead portion of the reception data received by the network IF 13B and descrambles the payload portion of the reception data.

When the data is sent from the network IF 13B to the switch unit 12B, the transmission device 10B extracts the encoded generator polynomial from the overhead portion of the transmission data and determines a generator polynomial different from the extracted generator polynomial. The network IF 13B of the transmission device 10B then uses the determined generator polynomial to scramble the data. The switch unit 12B of the transmission device 10B then extracts the encoded generator polynomial from the overhead portion of the reception data and descrambles the payload portion.

For example, when the optical module 13A-6 of the network IF 13A turns OFF while transmitting the frame and the subsequently output data are all 0 bits, the descramble processing unit 13B-6 functions as a scrambler. However, the generator polynomials to be used during scrambling are different in the network IF 13A and the network IF 13B when transmitting data from the network IF 13B to the switch unit 12B. Consequently, a transmission path abnormality is not generated because the data made up completely of 0 bits is not recovered on the reception side of the switch unit 12B, and the data is transmitted to a later stage of the switch unit 12B without the transmission path warning detection unit 12B-2 detecting a transmission path warning.

(Scramble Processing Unit (Descramble Processing Unit) According to First Embodiment)

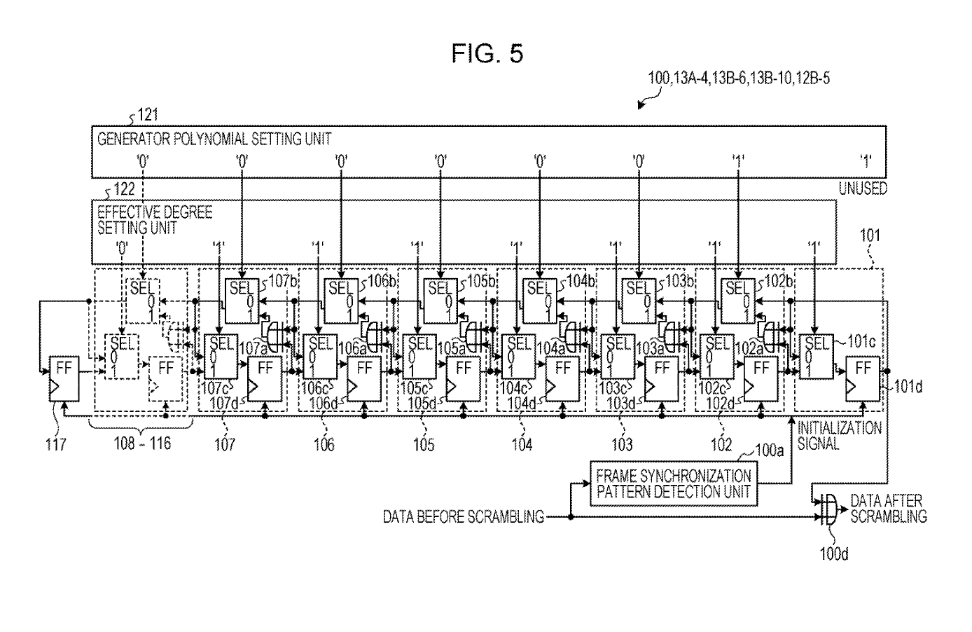

FIG. 5 is a block diagram illustrating an example of a scramble processing unit (descramble processing unit) according to the first embodiment. A scramble processing unit 100 according to the first embodiment illustrated in FIG. 5 is an exemplary embodiment of a circuit that carries out scramble processing (descramble processing) using an arbitrary generator polynomial by reading the code of a generator polynomial that has a maximum order of 16 degrees as illustrated as an example in FIGS. 3A and 3B.

That is, FIG. 5 illustrates an example of the scramble processing unit 100 that carries out scramble processing with an arbitrary generator polynomial by incorporating a code of a generator polynomial and the effective length of the generator polynomial obtained from the maximum order of the generator polynomial. In synchronized scramble processing, the descramble processing unit may be the same circuit as the scramble processing unit. Therefore, the scramble processing unit 100 illustrated in FIG. 5 corresponds to the scramble processing units 13A-4 and 13B-10 and the descramble processing units 13B-6 and 12B-5 illustrated in FIG. 4.

The scramble processing unit 100 includes a frame synchronization pattern detection unit 100a and an exclusive OR (XOR) gate 100d. Moreover, the scramble processing unit 100 includes logical blocks 101 to 116. The scramble processing unit 100 also includes a flip-flop (FF) 117. The scramble processing unit 100 also includes a generator polynomial setting unit 121 and an effective degree setting unit 122.

The generator polynomial setting unit 121 sets a code corresponding to the generator polynomial information stored in the overhead of the frame illustrated in FIG. 2 and uses the generator polynomial corresponding to the code to scramble the target data. For example, when the generator polynomial is 1+X⁶+X⁷, the code corresponding to the generator polynomial information stored in the overhead of the frame would be 0000011. Therefore, 1100000 is set in order from the start of the code by the generator polynomial setting unit 121. The 0 bits are set as far as the 16th bit following the code 1100000 by the generator polynomial setting unit 121.

The first bit 1 at the start of the code 1100000 set by the generator polynomial setting unit 121 is an unused bit. The second bit 1 in the code 1100000 set by the generator polynomial setting unit 121 is set to a selector 102b of the logical block 102. Similarly, the third bit 0 in the code 1100000 set by the generator polynomial setting unit 121 is set to a selector 103b of the logical block 103. Similarly thereafter, the seventh bit 0 in the code 1100000 set by the generator polynomial setting unit 121 is set to a selector 107b of the logical block 107. The bits after the seventh bit 0 in the code 1100000 set by the generator polynomial setting unit 121 are set to the logical blocks 108 to 116 as bit 0.

Moreover, the effective degree setting unit 122 sets a seven digit 1111111 in order from the start of the code because the effective degree is 7 degrees when the generator polynomial is 1+X⁶+X⁷. The bits after 1111111 are set at 0 as far as the 16th bit by the effective degree setting unit 122 for the generator polynomial.

The logical block 101 includes a selector 101c and a FF 101d. The selector 101c inputs the output of the FF 102d to the FF 101d when the bit 1 is set to the selector 101c by the effective degree setting unit 122.

The logical blocks 102 to 116 have similar configurations. For example, the logical block 102 includes an XOR gate 102a, the selector 102b, the logical block 102c, and the FF 102d. The logical blocks 103 to 116 each has a configuration similar to the logical block 102. For example, when the bit 1 is selected by the generator polynomial setting unit 121, the selector 102b outputs the output of the XOR gate 102a, which takes the XOR of the FF 101d and the FF 102d, to the selector 103b and the selector 102c. Moreover, the selector 102c, for example, inputs the output of the FF 103d to the FF 102d when the bit 1 is set by the effective degree setting unit 122.

Here, the ith (where i is a natural number from 1 to 16) bit set by the effective degree setting unit 122 in the generator polynomial is the bit corresponding to the logical block j (where j corresponds respectively to 101 to 116). Moreover, the ith (where i is a natural number from 1 to 16) bit set by the generator polynomial setting unit 121 is the bit corresponding to the logical block j (where j corresponds respectively to 101 to 116). For the logical blocks j and (j+1) for which bit 1 is set by the generator polynomial setting unit 121 (where j=101 to 116), the logical block (j+1) is regarded as the front stage and the logical block j is regarded as the latter stage. Alternatively, for the logical blocks j and (j−1) for which bit 1 is set by the generator polynomial setting unit 121 (where j=101 to 116), the logical block j is regarded as the current stage and the logical block (j−1) is regarded as the subsequent stage.

The scramble processing unit 100 transmits an initialization signal to initialize the FFs 101c1 to 107d (and the FFs corresponding to the logical blocks 108 to 116) and an FF 117 at a value of bit 0 when data to be scrambled is detected by the frame synchronization pattern detection unit 100a. When the contents held by each FF are cyclically output from the front stage to the latter stage for each clock among the logical blocks made effective by the effective degree setting unit 122, the scramble processing unit 100 takes the XOR of the contents held by each FF in the current stage and the subsequent stage, which have been made effective by the generator polynomial setting unit 121. That is, the scramble processing unit 100 uses the XOR gate 100d to take the exclusive OR of the data before scrambling and the bit string in which the bits held by each of the enabled FFs are appropriately inverted so that the DC balance is ensured. The scramble processing unit 100 then is able to scramble the pre-scrambled data so that the DC balance is ensured, by outputting the XOR result of the XOR gate 100d.

(Processing to Determine Generator Polynomial According to the First Embodiment)

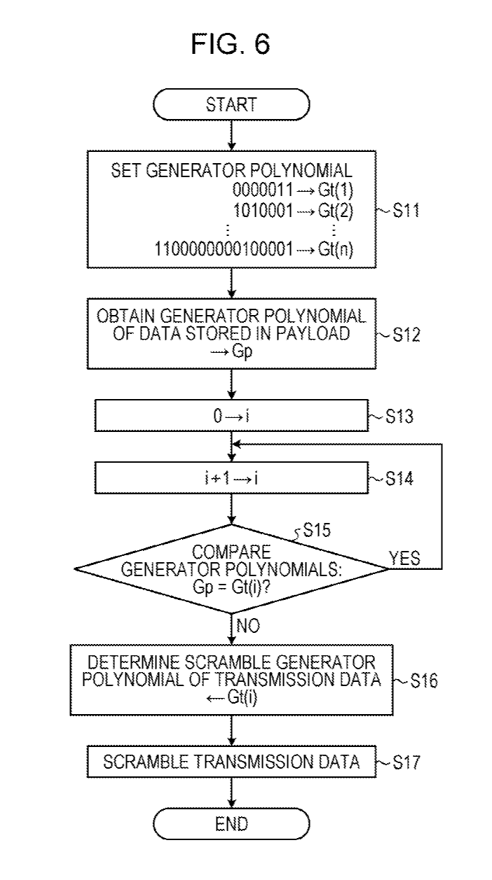

FIG. 6 is an operational flowchart for an example of processing to determine a generator polynomial according to the first embodiment. The processing to determine a generator polynomial according to the first embodiment is executed by a predetermined processing unit, such as the generator polynomial determination units 13A-2 and 13B-9 illustrated in FIG. 4.

First, the predetermined processing unit sets a generator polynomial in a temporary storage region (step S11). For example, the predetermined processing unit sets generator polynomials Gt(1) to Gt(n) (where n is a natural number) as depicted below. The predetermined processing unit, for example, sets the bit string 0000011 (generator polynomial 1+X⁶+X⁷) as Gt(1) and the bit string 1010001 (generator polynomial 1+X+X³+X⁷) as Gt(2). Further, the predetermined processing unit, for example, sets the bit string 1100000000100001 (generator polynomial 1+X²+X³+X¹¹+X¹⁶) as Gt(n). The generator polynomials Gt(1) to Gt(n) may be previously stored in a predetermined table.

Next, the predetermined processing unit obtains, from the overhead of the received data, the code of the generator polynomial used for scrambling the scrambled data stored in the payload of the received data, and sets the specified generator polynomial as Gp (step S12). Here, Gp is a descramble generator polynomial for the received data or a generator polynomial for a protocol or test data stored in the payload portion of the received data.

Next, the predetermined processing unit initializes a counter i to 0 (step S13). Next, the predetermined processing unit increments the counter i by 1 (step S14). Next, the predetermined processing unit determines whether the generator polynomial Gp obtained in step S12 matches Gt(i) (step S15). When the predetermined processing unit determines that the generator polynomial Gp obtained in step S12 matches Gt(i) (step S15: Yes), the processing moves to step S14. However, when the predetermined processing unit determines that the generator polynomial Gp obtained in step S12 does not match Gt(i) (step S15: No), the processing moves to step S16.

In step S16, the predetermined processing unit determines that the Gt(i) that is found not to match the generator polynomial Gp in step S15, as the generator polynomial for scrambling the transmission data. The generator polynomial of the transmission data may be selected according to whether the generator polynomial is one that is able to ensure an effective cyclic bit length according to a receiving port, a channel, a transmission path of the data, a protocol used in the reception data and encapsulated data, or the transmission data length. The predetermined processing unit then scrambles the target data with the generator polynomial Gt(i), stores the scrambled target data in the payload of the transmission data, and stores the code of the generator polynomial Gt(i) in the overhead of the transmission data (step S17). The predetermined processing unit transmits the transmission data and completes the generator polynomial determination processing when step S17 is completed.

According to the first embodiment, target data that has been scrambled using a generator polynomial is descrambled, and a generator polynomial different from the generator polynomial used in the previous scrambling is used for scrambling when rescrambling the data. Consequently according to the first embodiment, a generator polynomial is able to be changed dynamically for each scrambling process, that is, for each set of transmission data, and unintentional scrambling or descrambling of the scrambled data within the data by use of the same generator polynomial may be avoided. As a result, continuously transmitting the same code on the transmission path is avoided and consequently a stable clock is able to be extracted from the reception data in the first embodiment. Moreover, installation of a scramble processing unit corresponding to an assumed generator polynomial is unnecessary because an arbitrary generator polynomial is able to be set in the scramble processing unit in the first embodiment. As a result, the size of the circuit of the scramble processing unit that is able to use a multitude of generator polynomials is reduced in the first embodiment.

For example, when an output stopped state arises, such as when the optical module 13A-6 of the network IF 13A is turned OFF during frame transmission, the data including a continuation of 0 bits is inputted to the network IF 13B in FIG. 4. In this case, when the descramble processing unit 13B-6 uses the same generator polynomial as the scramble processing unit 13A-4, scrambling is carried out on the data including a continuation of 0 bits instead of descrambling. Consequently, the scramble processing unit 13B-10 carries out descrambling instead of scrambling. As a result, a signal including a continuation of 0 bits is reproduced as the input to the switch unit 12B and the transmission path warning detection unit 12B-2 detects a transmission path abnormality regardless of whether or not there is a problem in the transmission path between the network IF 13B and the switch unit 12B.

Moreover, when, for example, a signal of another protocol in the payload of a certain protocol is mapped in a network including different protocols passing therethrough, the data to be mapped may already be scrambled. Moreover, a cyclic code that uses a generator polynomial, such as a PN code, stored as a pseudo random pattern in a payload portion in a test frame and the like, is similar to scrambled data. In this case, the transmission device descrambles the scrambled data when carrying out data scrambling, and unscrambled signals having the same continuous code are transmitted over the transmission path.

In the first embodiment, a generator polynomial used when the scramble processing unit 13A-4 of the network IF 13A scrambles the data is differentiated from a generator polynomial used when the descramble processing unit 13B-6 descrambles the data. As a result, the reproduction of the continuation of the same codes in a specific pattern may be avoided in the first embodiment. Moreover, the generator polynomial used in scrambling is encoded and included in the overhead of the transmission data when transmitted in the first embodiment. Consequently, a generator polynomial that avoids the problem of reproducing a continuation of the same codes may be selected with a simple configuration even in a network that uses a multitude of protocols.

### Embodiment 2

### Block of Transmission Device According to a Second Embodiment

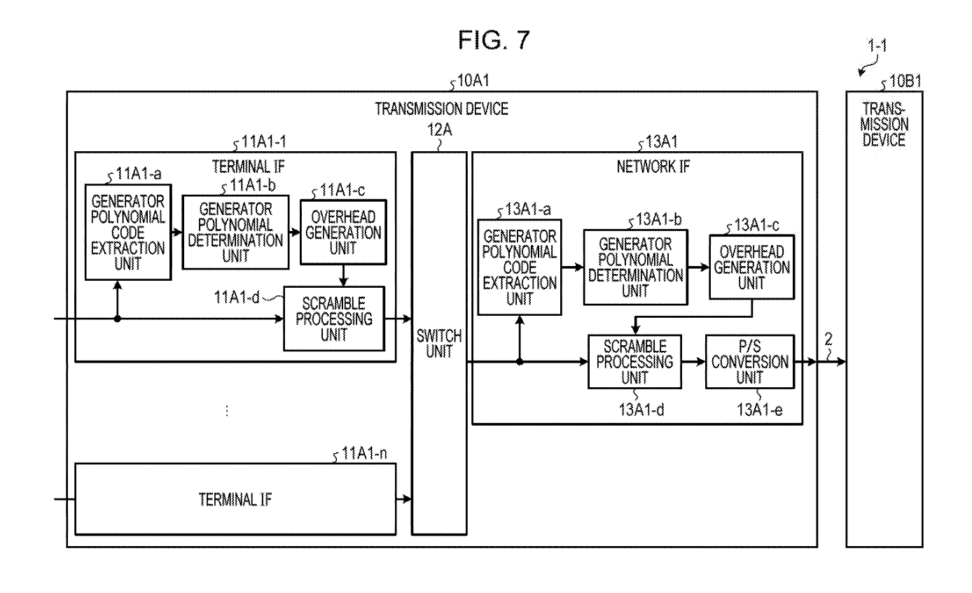

FIG. 7 is a block diagram of an example of a transmission system according to a second embodiment. A transmission system 1-1 of the second embodiment illustrates a case in which data of the scrambled target data is encapsulated in multiple stages in the same transmission device in comparison to the transmission system 1 in the first embodiment. As illustrated in FIG. 7, the transmission system 1-1 includes transmission devices 10A1 and 1061 coupled to each other over the transmission path 2. The transmission device 10A1 is on the transmission side and the transmission device 1061 is on the reception side in FIG. 7 for ease of explanation. Moreover, a portion of the functional configurations which are not important to the disclosed technique is omitted.

The transmission device 10A1 includes terminal interface (IF) units 11A1-1 to 11A1-n, the switch unit 12A, and a network IF 13A1. The configurations of the terminal IFs 11A1-1 to 11A1-n are the same and the terminal IF 11A1-1 is described in detail as an example. The terminal IF 11A1-1 includes a generator polynomial code extraction unit 11A1-a, a generator polynomial determination unit 11A1-b, an overhead generation unit 11A1-c, and a scramble processing unit 11A1-d.

The generator polynomial code extraction unit 11A1-a extracts the code of the generator polynomial stored in the overhead, from the reception data received from an unillustrated terminal, and specifies the generator polynomial. The generator polynomial determination unit 11A1-b determines a generator polynomial different from the generator polynomial specified by the generator polynomial code extraction unit 11A1-a. The method for determining the generator polynomial by the generator polynomial determination unit 11A1-b is the same as in the first embodiment. The overhead generation unit 11A1-c generates transmission data by encoding the generator polynomial determined by the generator polynomial determination unit 11A1-b and storing the encoded information into the overhead of the transmission data. The scramble processing unit 11A1-d uses the generator polynomial determined by the generator polynomial determination unit 11A1-b to scramble the reception data and stores the scrambled data in the payload of the transmission data. That is, the scramble processing unit 11A1-d uses a generator polynomial different from the generator polynomial used for scrambling the target data of the reception data, to scramble whole of the reception data, stores the scrambled data in the payload, and encodes the different generator polynomial and stores the encoded information for the different generator polynomial in the overhead. As a result, the scramble processing unit 11A1-d generates the transmission data which encapsulates the reception data.

The switch unit 12A carries out forwarding control on the transmission data outputted from the terminal IFs 11A1-1 to 11A1-n, and outputs the transmission data to the network IF 13A1.

The network IF 13A1 includes a generator polynomial code extraction unit 13A1-a, a generator polynomial determination unit 13A1-b, an overhead generation unit 13A1-c, a scramble processing unit 13A1-d, and a parallel/serial (P/S) conversion unit 13A1-e.

The generator polynomial code extraction unit 13A1-a extracts the code of the generator polynomial stored in the overhead, from the reception data received from the terminal IFs 11A1-1 to 11A1-n, and specifies the generator polynomial. The generator polynomial determination unit 13A1-b determines a generator polynomial different from the generator polynomial specified by the generator polynomial code extraction unit 13A1-a. The method for determining the generator polynomial by the generator polynomial determination unit 13A1-b is the same as in the first embodiment. The overhead generation unit 13A1-c generates transmission data by encoding the generator polynomial determined by the generator polynomial determination unit 13A1-b and storing the encoded information in the overhead of the transmission data. The scramble processing unit 13A1-d uses the generator polynomial determined by the generator polynomial determination unit 13A1-b to scramble the reception data and stores the scrambled data in the payload of the transmission data. That is, the scramble processing unit 13A1-d uses the generator polynomial different from the generator polynomial used for scrambling the target data of the reception data, to scramble whole of the reception data, stores the scrambled data in the payload, and encodes the different generator polynomial and stores the encoded information in in the overhead. As a result, the scramble processing unit 13A1-d generates the transmission data which encapsulates the reception data. The P/S conversion unit 13A1-e transmits the transmission data generated by the scramble processing unit 13A1-d to the transmission device 10131 via the transmission path 2.

(Multistage Encapsulating According to the Second Embodiment)

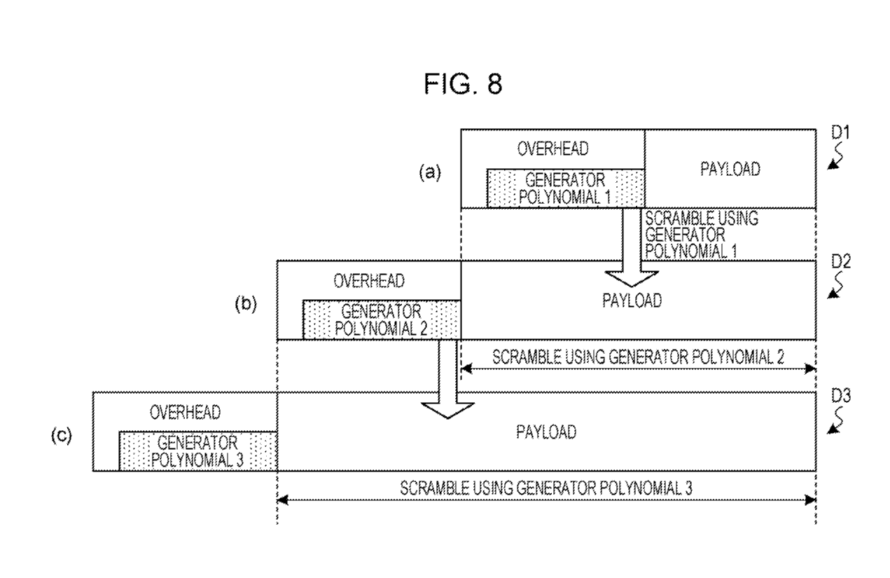

FIG. 8 is a view illustrating an example of multistage encapsulating according to the second embodiment. For example, as illustrated in (a) in FIG. 8, the terminal IF 11A1-1 in FIG. 7 receives data D1 whose overhead storing the code of a generator polynomial 1 and whose payload storing the target data scrambled using the generator polynomial 1, from an unillustrated terminal. In this case, the generator polynomial determination unit 11A1-b of the terminal IF 11A1-1 uses a generator polynomial 2 that is different from the generator polynomial 1, to scramble whole of the data D1 and store the scrambled data in the payload of the data D2 ((b) in FIG. 8), and stores the generator polynomial 2 in the overhead of the data D2.

Furthermore, it is assumed that the network IF 13A1 illustrated in FIG. 7 receives the data D2 from the terminal IF 11A1-1 via the switch unit 12A. In this case, the generator polynomial determination unit 13A1-b of the network IF 13A1 uses a generator polynomial 3 different from the generator polynomial 1 and the generator polynomial 2, to scramble whole of the data D2. The generator polynomial determination unit 13A1-b then stores data obtained by scrambling whole of the data D2 in the payload of data D3 ((c) in FIG. 8), and stores the generator polynomial 3 in the overhead of the data D3.

In this way in the second embodiment, the generator polynomial code is extracted before the scramble processing by the transmitter device even when test data or scrambled data of a different protocol is encapsulated in the payload portion of the transmission data. Moreover, a generator polynomial different from the extracted generator polynomial is used to further scramble the data in the second embodiment. As a result in the second embodiment, unintentional descrambling or scrambling is avoided even when encapsulating data or even when encapsulating data in multiple stages, and scrambled data retaining a suitable DC balance may be transmitted.

### Embodiment 3

### Block of Transmission Device According to a Third Embodiment

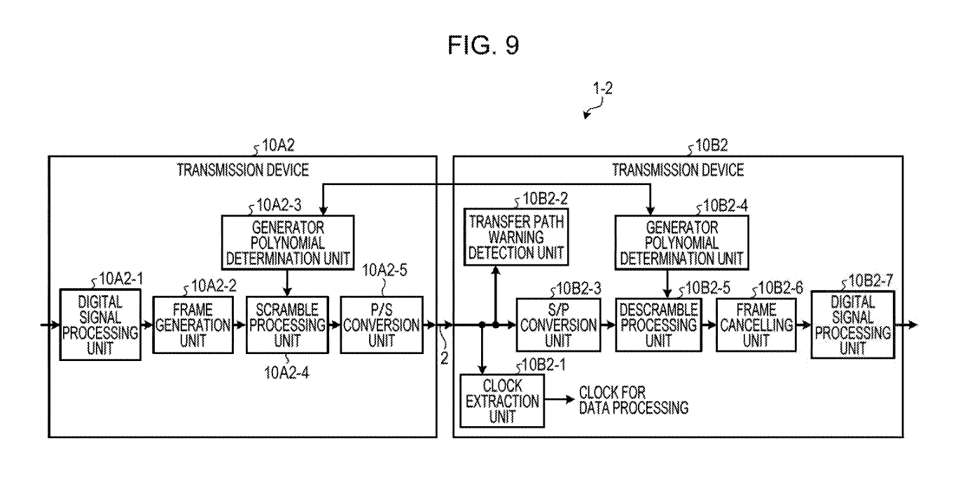

FIG. 9 is a block diagram of an example of a transmission system according to a third embodiment. A transmission system 1-2 of the third embodiment illustrates a case in which a generator polynomial and an update timing of the generator polynomial are determined by the transmission devices on the transmission and reception sides by using software, and the generator polynomials are synchronized in the transmission devices on the transmission and reception sides via communication between pieces of software of the transmission devices. As illustrated in FIG. 9, the transmission system 1-2 includes transmission devices 10A2 and 10132 which are coupled via the transmission path 2. The transmission device 10A2 is on the transmission side and the transmission device 10132 is on the reception side in FIG. 9 for ease of explanation. Moreover, a portion of the functional configurations which are not important to the disclosed technique is omitted in FIG. 9.

The transmission device 10A2 includes a digital signal processing unit 10A2-1, a frame generation unit 10A2-2, a generator polynomial determination unit 10A2-3, a scramble processing unit 10A2-4, and a parallel/serial (P/S) conversion unit 10A2-5. Moreover, the transmission device 10132 includes a clock extraction unit 1062-1, a transmission path warning detection unit 10132-2, a serial/parallel conversion unit 10132-3, and a generator polynomial determination unit 1062-4. The transmission device 10B-2 also includes a descramble processing unit 10132-5, a frame cancelling unit 1062-6, and a digital signal processing unit 1062-7.

The digital signal processing unit 10A2-1 in the transmission device 10A2 carries out digital signal processing on the reception data. The frame generation unit 10A2-2 generates a frame for storing the reception data. The generator polynomial determination unit 10A2-3 synchronizes with the generator polynomial determination unit 1062-4 of the transmission device 10132 via software communication and changes the generator polynomial at a predetermined period. The scramble processing unit 10A2-4 uses the generator polynomial determined by the generator polynomial determination unit 10A2-3 to scramble the target data and stores the scrambled data in the payload of the frame. The P/S conversion unit 10A2-5 carries out parallel-serial conversion on the data scrambled by the scramble processing unit 10A2-4 and transmits the converted data to the transmission device 1062.

The clock extraction unit 1062-1 in the transmission device 1062 extracts the clock from the data received from the transmission device 10A2. Further, the transmission path warning detection unit 1062-2 detects a transmission path abnormality such as a continuation of a predetermined number of 0 bits in the data received from the transmission device 10A2. The S/P conversion unit 1062-3 carries out serial-parallel conversion on the data received from the transmission device 10A2. The descramble processing unit 1062-5 uses the generator polynomial determined by the generator polynomial determination unit 1062-4 to descramble the data subjected to serial-parallel conversion by the S/P conversion unit 1062-3. The generator polynomial is synchronized between the generator polynomial determination unit 1062-4 and the generator polynomial determination unit 10A2-3. Consequently, the descramble processing unit 1062-5 able to descramble the target data by using the same generator polynomial as the scramble processing unit 10A2-4.

The frame cancelling unit 1062-6 cancels the frame of the data descrambled by the descramble processing unit 1062-5. The digital signal processing unit 1062-7 carries out digital signal processing on the data stored in the payload of the frame canceled by the frame cancelling unit 1062-6. The digital signal processing unit 1062-7 outputs the data subjected to the digital signal processing to a subsequent stage.

In this way, the generator polynomial is synchronized through software communication in the transmission device 10A2 on the transmission side and the transmission device10B2 on the reception side, according to the third embodiment. Therefore, scrambling may be carried out properly in the third embodiment without embedding the generator polynomial information in the data transmitted, for example, from the transmission device 10A2 to the transmission device 1062. For example, the third embodiment is applied even with transmission data of a format in which a communication protocol between the transmission device 10A2 and the transmission device 1062 does not accompany the overhead. Because the generator polynomial is changed at a predetermined timing while being synchronized between the transmission side and the reception side transmission devices 10A2 and 1062, the generation of unintentionally scrambled or descrambled data using the same generator polynomial is avoided.

The update timing of the generator polynomial may be a timing when the scrambled transmission data includes data in which the same value such as bit 0 or bit 1, for example, is continued for a predetermined number.

### Embodiment 4

### Block of Transmission Device According to a Fourth Embodiment

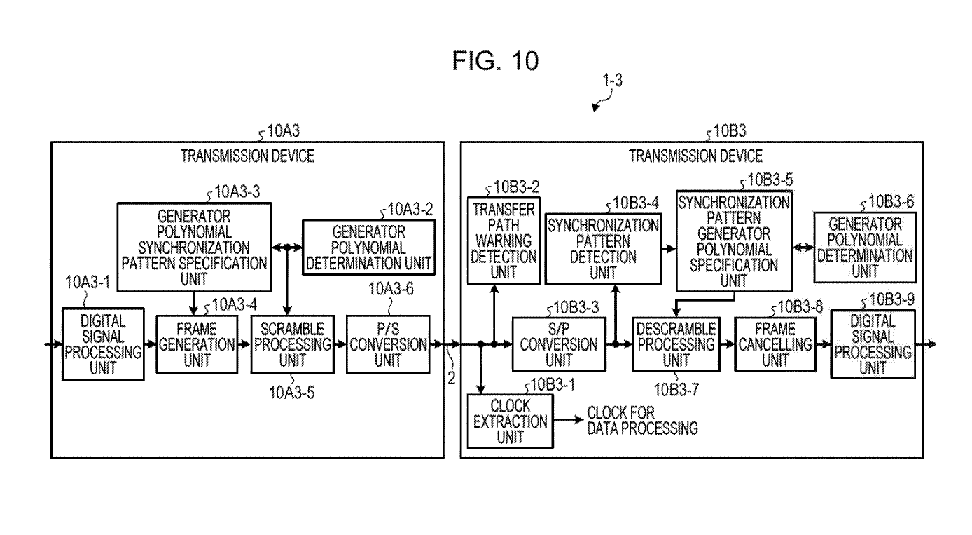

FIG. 10 is a block diagram of an example of a transmission system according to a fourth embodiment. A transmission system 1-3 of the fourth embodiment previously establishes, in an unillustrated association table and the like, an association between a synchronization pattern and a generator polynomial in a format that includes a synchronization pattern as illustrated in FIG. 2. The transmission side transmission device adds the synchronization pattern associated with the generator polynomial of the scrambled target data, to the transmission data, and transmits the transmission data. The reception side transmission device then uses the generator polynomial corresponding to the detected synchronization pattern to descramble the target data. In the fourth embodiment, the combination of the synchronization pattern and the generator polynomial is synchronized between the transmission device 10A3 and the transmission device 1063 by causing software to rewrite the association tables to enter the same state, thereby changing the generator polynomial.

As illustrated in FIG. 10, the transmission system 1-3 includes transmission devices 10A3 and 1063 which are coupled via the transmission path 2. The transmission device 10A3 is on the transmission side and the transmission device 10133 is on the reception side in FIG. 10 for ease of explanation. Moreover, a portion of the functional configurations which are not important to the disclosed technique is omitted in FIG. 10.

The transmission device 10A3 includes a digital signal processing unit 10A3-1, a generator polynomial determination unit 10A3-2, a generator polynomial synchronization pattern specification unit 10A3-3, a frame generation unit 10A3-4, a scramble processing unit 10A3-5, and a parallel/serial (P/S) conversion unit 10A3-6. The transmission device 10133 includes a clock extraction unit 10133-1, a transmission path warning detection unit 10133-2, a serial/parallel (S/P) conversion unit 10133-3, a synchronization pattern extraction unit 10133-4, and a synchronization pattern generator polynomial specification 10133-5. The transmission device 10133 also includes a generator polynomial determination unit 10133-6, a descramble processing unit 10133-7, a frame cancelling unit 10133-8, and a digital signal processing unit 10133-9.

The digital signal processing unit 10A3-1 in the transmission device 10A3 carries out digital signal processing on the reception data. The generator polynomial determination unit 10A3-2 determines a generator polynomial for scrambling the reception data. The generator polynomial synchronization pattern specification unit 10A3-3 refers to the unillustrated association table for the generator polynomial and the synchronization pattern, and specifies the synchronization pattern corresponding to the generator polynomial determined by the generator polynomial determination unit 10A3-2. The association table for the generator polynomial and the synchronization pattern is synchronized with the transmission device 10133 and is maintained as the same table. The frame generation unit 10A3-4 generates a frame including the synchronization pattern specified by the generator polynomial synchronization pattern specification unit 10A3-3. The scramble processing unit 10A3-5 uses the generator polynomial determined by the generator polynomial determination unit 10A3-2 to scramble the target data and stores the scrambled data in the payload of the frame. The P/S conversion unit 10A3-6 carries out P/S conversion on the transmission data to which the synchronization pattern has been added by the frame generation unit 10A3-4 and which has the target data scrambled by the scramble processing unit 10A3-5 stored in the payload, and transmits the transmission data to the transmission device 10133.

The clock extraction unit 10133-1 in the transmission device 10133 extracts the clock from the data received from the transmission device 10A3. Further, the transmission path warning detection unit 10133-2 detects a transmission path abnormality such as a continuation of a predetermined number of 0 bits in the data received from the transmission device 10A3. The S/P conversion unit 10133-3 carries out serial-parallel conversion on the data received from the transmission device 10A3. The synchronization pattern extraction unit 10133-4 extracts the synchronization pattern from the data received from the transmission device 10A3. The synchronization pattern generator polynomial specification unit 10133-5 refers to the unillustrated association table for the generator polynomial and the synchronization pattern, and specifies the generator polynomial corresponding to the synchronization pattern extracted by the synchronization pattern extraction unit 10133-4. The synchronization pattern generator polynomial specification unit 10133-5 then obtains the specified generator polynomial from the generator polynomial determination unit 10133-6 and reports the generator polynomial to the descramble processing unit 10133-7. The descramble processing unit 10133-7 then uses the generator polynomial reported by the synchronization pattern extraction unit 10133-4 to descramble data received from the transmission device 10A3. The synchronization pattern generator polynomial specification unit 10133-5 and the generator polynomial determination unit 10133-6 are synchronized with the synchronization pattern generator polynomial specification unit 10A3-3 and the generator polynomial determination unit 10A3-2, with respect to the generator polynomials. Consequently, the descramble processing unit 10133-7 is able to use the same generator polynomial as the scramble processing unit 10A3-5 to descramble the target data.

The frame cancelling unit 10133-8 cancels the frame of the data descrambled by the descramble processing unit 10133-7. The digital signal processing unit 10133-9 carries out digital signal processing on the data stored in the payload of the frame canceled by the frame cancelling unit 1063-8. The digital signal processing unit 10133-9 outputs the data subjected to the digital signal processing to a subsequent stage.

In this way, because the generator polynomial is specified using the synchronization pattern during scrambling and descrambling according to the fourth embodiment, the generator polynomial is synchronized and switched without embedding the generator polynomial information in the overhead.

The update timing of the association between the generator polynomial and the synchronization pattern may be a timing when the scrambled transmission data includes data in which the same value such as bit 0 or bit 1, for example, is continued for a predetermined number.

### Embodiment 5

While the first to fourth embodiments have been discussed above, the disclosed techniques include the following modified examples. Other modified examples other than the examples according to the disclosed techniques are explained as a fifth embodiment.

(1) Scrambling Method

While the synchronization scrambling in which the scramble and descramble processing units use the same circuit has been discussed in the first to fourth embodiments, the disclosed techniques may also be applied to self-synchronized scrambling.

(2) Generator Polynomials Synchronized Between Transmission Devices

The generator polynomials are synchronized between the transmission devices by storing the generator polynomial information in the overhead of the transmission data in the first and second embodiments. The information pertaining to the generator polynomial is synchronized by software communication and the like between the transmission devices in the third and fourth embodiments. However, the transmitted and received generator polynomials may be mistaken due to a bit error and the like when transferring the generator polynomial information via the transmission path. Consequently, in order to avoid bit errors and the like of generator polynomial information to be transferred, an error correcting code such as ECC or FEC may be applied to the information pertaining to the generator polynomial or to the overhead portion including the generator polynomial, and transmission errors of the generator polynomials may be reduced. ECC stands for “error detection and correction” and FEC stands for “forward error correction”.

(3) Order of Scramble Processing and Frame Generation

A generator polynomial after the frame generation is used to scramble the target data and the scrambled target data is stored in the payload of the generated frame in the first to fourth embodiments. However, the frame may be generated after using the generator polynomial to scramble the target data and the scrambled data may be stored in the payload of the generated frame in the disclosed techniques.

The constituent elements of the illustrated parts in the above embodiments are not necessarily configured physically as illustrated. In other words, the embodiments are not limited to the particular forms of distribution and integration of each part and all or some of the parts may be configured to be functionally or physically distributed or integrated in arbitrary units according to the type of load or usage conditions and the like.

All of or arbitrary portions of the various functional processes carried out by the devices may be executed by a central processing unit (CPU). Alternatively, the various functional processes carried out by the devices may be carried out as a whole or partially on a microcomputer such as an NP, an MPU, an MCU, an ASIC, or an FPGA and the like. NP stands for a network processor, MPU stands for a microprocessing unit, MCU stands for a microcontroller unit, ASIC stands for an application specific integrated circuit, and FPGA stands for a field-programmable gate array. Moreover, the various processing functions may also be conducted in part or in whole on a program that conducts analysis with the CPU (or a microcomputer such as an MPU or MCU), or on hardware based on wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission system comprising:
a transmission device including a first processor, the first processor being configured to store a first generator polynomial in a portion of a first data scrambled by using the first generator polynomial, and transmit the first data including the first generator polynomial; and
a reception device including a second processor, the second processor being configured to:
receive the first data,
descramble the first data by using the first generator polynomial, and
generate a second data by scrambling the descrambled first data by using a second generator polynomial different from the first generator polynomial.

2. A transmission system comprising:
a transmission device including a first processor, the first processor being configured to:
scramble a target data by using a first generator polynomial,
generate a first data by storing the scrambled target data in a payload of the first data, and
transmit the first data; and
a reception device including a second processor, the second processor being configured to:
receive the first data,
descramble the target data stored in a payload of the first data by using the first generator polynomial,
scramble the descrambled target data by using a second generator polynomial different from the first generator polynomial,
generate a second data by storing the scrambled target data in a payload of the second data, and
transmit the second data.

3. The transmission system of claim 2, wherein
the first processor of the transmission device adds information corresponding to the first generator polynomial to the first data;
the second processor of the reception device uses the first generator polynomial corresponding to the information added to the first data to descramble the target data stored in a payload of the first data; and
the second processor of the reception device adds information corresponding to the second generator polynomial to the second data.

4. A transmission device comprising:
a processor configured to:
scramble first target data by using a first generator polynomial;
add first information corresponding to the generator polynomial, and generate first data by storing the scrambled first target data in a payload of the first data; and
transmit the first data.

5. The transmission device of claim 4, wherein
the processor is further configured to:
scramble the first data by using a second generator polynomial different from the first generator polynomial,
generate second data to which second information corresponding to the second generator polynomial is added, the second data including a payload in which the scrambled first data is stored, and
transmit the second data.

6. The transmission device of claim 4, wherein
the processor is further configured to:
receive data,
extract third information corresponding to a third generator polynomial from the received data, and
descramble second target data included in the data by using the third generator polynomial corresponding to the extracted third information.
